(19) United States
(12) Patent Application Publication
(10) Pub. No.: US 2010/0228452 A1
(43) Pub. Date: Sep. 9, 2010

(54) HYDRAULIC PRESSURE CONTROLLING APPARATUS

(75) Inventors: Masahiro Hosoya, Kariya-shi (JP); Yasuo Shirai, Chiryu-shi (JP); Masami Osawa, Nagoya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/716,090

(22) Filed: Mar. 2, 2010

(30) Foreign Application Priority Data
Mar. 9, 2009 (JP) 2009-055372

(51) Int. Cl. G06F 19/00

(52) U.S. Cl. 701/51

(57) ABSTRACT

A hydraulic pressure controlling apparatus includes a hydraulic pressure controlling portion controlling a hydraulic pressure supplied to engagement elements of an automatic transmission apparatus, a mechanical oil pump supplying the hydraulic pressure to the hydraulic pressure controlling portion, an electric oil pump supplying the hydraulic pressure to a starting shift stage engagement element, a first check valve provided at a first hydraulic conduit, allowing a supply of the hydraulic pressure from the electric oil pump to the starting shift stage engagement element and interrupting an inverse supply of the hydraulic pressure, and an electronic controlling portion controlling operations of the hydraulic pressure controlling portion, a power source and the electronic oil pump, wherein the electric oil pump supplies the hydraulic pressure to the starting shift stage engagement element via the first hydraulic conduit, which differs from a second hydraulic conduit and at which the first check valve is provided.

### CROSS REFERENCE TO RELATED APPLICATIONS

This application is based on and claims priority under 35 U.S.C. §119 to Japanese Patent Application 2009-055372, filed on Mar. 9, 2009, the entire content of which is incorporated herein by reference.

### TECHNICAL FIELD

This disclosure generally relates to a hydraulic pressure controlling apparatus for controlling a hydraulic pressure supplied to an engagement element of a hydraulic automatic transmission apparatus mounted on a vehicle.

### BACKGROUND

There exists an engine stop-and-start controlling apparatus for executing a control of automatically stopping an engine when an engine stopping condition is satisfied in a case where a vehicle stops at an intersection and the like while traveling and re-starting the engine when an engine starting condition is satisfied when the vehicle starts moving afterwards. The engine stop-and-start controlling apparatus may include a hydraulic pressure controlling device for controlling a hydraulic pressure so that sufficient operation oil is supplied to an engagement element of a hydraulic automatic transmission in order to reduce a shock generated when clutches of the hydraulic automatic transmission are engaged when the engine is re-started.

Disclosed in JPH8-14076A is an engine automatically stopping-and-starting apparatus used for a vehicle having a hydraulic automatic transmission, which is configured so as to switch to various shift stages by using a hydraulic pressure supplied thereto from a hydraulic pressure source, which generates the hydraulic pressure in response to an operation of an engine as an operation hydraulic pressure. Furthermore, the engine automatically stopping-and-starting apparatus disclosed in JPH8-14076A includes a hydraulic pressure maintaining means for maintaining the operation hydraulic pressure at a certain level even when the engine is stopped, a group of sensors for detecting states of the engine and each portion of the vehicle, an engine stopping means for stopping the engine in a case where a condition for stopping the engine without relying on an operation of an ignition key is determined to be satisfied on the basis of a detection signal outputted from the sensors, an engine re-starting means for re-starting the engine in a case where a condition for re-starting the engine without relying on the operation of the ignition key is determined to be satisfied on the basis of the detection signal outputted from the sensors, and a down time processing means for controlling the hydraulic automatic transmission to establish a starting shift stage after the engine is stopped by the engine stopping means and before the engine is re-started by the engine re-starting means. The hydraulic pressure maintaining means includes a check valve for preventing the oil to flow from a hydraulic pressure unit for the clutch to the hydraulic pressure source (a reverse flow of the oil) and a hydraulic pressure supplying means (an accumulator) for supplying the hydraulic pressure to the hydraulic unit for the clutch without relying on a driving force of the engine. The check valve and the hydraulic pressure supplying means serve as a means for maintaining the operation hydraulic pressure of the hydraulic pressure unit for the clutch of the hydraulic automatic transmission.

Disclosed in JP2002-115755A is a hydraulic pressure controlling apparatus for a vehicle having a driving source, a transmission apparatus, which is actuated by a hydraulic pressure, an electric oil pump for supplying the hydraulic pressure to the transmission, an accumulator for accumulating the hydraulic pressure to be supplied to the transmission apparatus and a controlling means for controlling the electric oil pump and the accumulator. The controlling means supplies the hydraulic pressure to the transmission apparatus from the electric oil pump and the accumulator when the driving source is started.

A detailed configuration of the accumulator is not described in the engine stopping-and-starting apparatus disclosed in JPH8-14076A and the hydraulic pressure controlling apparatus disclosed in JP2002-115755A. However, when assuming that the accumulator is provided on a hydraulic pressure circuit of the automatic transmission, an additional and specific hydraulic pressure circuit including the accumulator may be needed. In this case, because the additional and specific hydraulic pressure circuit needs to be newly designed, a manufacturing costs of the engine stopping-and-starting apparatus and the hydraulic pressure controlling apparatus may increase. Furthermore, in a case where the accumulator is formed within the hydraulic pressure circuit of the automatic transmission, a length of a hydraulic pressure conduit from the accumulator to a starting clutch (i.e. a clutch used when the vehicle is started to move) provided within the automatic transmission may be increased, a number of portions at which the operation oil may leak may increase, and the accumulator may be enlarged because of other components of the automatic transmission. More specifically, according to the hydraulic pressure controlling apparatus disclosed in JP2002-115755A, the hydraulic pressure from a mechanical oil pump and the electric oil pump is supplied to the automatic transmission apparatus via a check ball mechanism for switching. A length of the hydraulic pressure conduit extending between the check ball mechanism for switching and the starting clutch provided within the automatic transmission apparatus becomes relatively long and a number of portions at which the operation oil leak increases, which may lead to an enlargement of the electric oil pump.

A need thus exists to provide a hydraulic pressure controlling apparatus which is not susceptible to the drawback mentioned above.

### SUMMARY

According to an aspect of this disclosure, a hydraulic pressure controlling apparatus includes a hydraulic pressure controlling portion controlling a hydraulic pressure supplied to plural engagement elements of an automatic transmission apparatus, a mechanical oil pump generating the hydraulic pressure and supplying the hydraulic pressure to the hydraulic pressure controlling portion in response to a driving of a power source, an electric oil pump generating the hydraulic pressure and supplying the hydraulic pressure to a starting shift stage engagement element, which is one of the plural engagement elements used for establishing a starting shift stage, a first check valve provided at a first hydraulic conduit extending between the starting shift stage engagement element and the electric oil pump, allowing a supply of the hydraulic pressure outputted from the electric oil pump to the starting shift stage engagement element and interrupting the hydraulic pressure to be reversely supplied from the starting shift stage engagement element to the electric oil pump, and an electronic controlling portion controlling operations of the hydraulic pressure controlling portion, the power source and the electronic oil pump on the basis of a signal indicating a predetermined state of a vehicle, wherein the electric oil pump supplies the hydraulic pressure to the starting shift stage engagement element via the first hydraulic conduit, which differs from a second hydraulic conduit connecting the hydraulic pressure controlling portion and the starting shift stage engagement element, and the first check valve is provided at the first hydraulic conduit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram schematically illustrating a configuration example of a hydraulic pressure controlling apparatus according to a first embodiment;

FIG. 2A is a skeleton diagram schematically illustrating a gear train of an automatic transmission adapted to the hydraulic pressure controlling apparatus according to the first embodiment;

FIG. 2B is a table schematically indicating relationships between first, second and third friction clutches, operation states of first and second friction brakes, and shift stages;

FIG. 3 is a flowchart schematically illustrating a control operation of the hydraulic pressure controlling apparatus according to the first embodiment; and

FIG. 4 is a diagram schematically illustrating a configuration example of a hydraulic pressure controlling apparatus according to a second embodiment.

### DETAILED DESCRIPTION

### Overview

A hydraulic pressure controlling apparatus according to embodiments includes a hydraulic pressure controlling portion 10 for controlling a hydraulic pressure to be supplied to plural engagement elements C1, C2, C3, B1 and B2 provided within an automatic transmission apparatus, a mechanical oil pump 2 for supplying the hydraulic pressure to the hydraulic pressure controlling portion in response to an operation of a power source 3, an electric oil pump 21 for supplying a hydraulic pressure to a starting shift stage engagement element C1 used for a starting shift stage out of plural engagement elements, a check valve 22, which is provided at a hydraulic conduit (a first hydraulic conduit 9a) extending between the starting shift stage engagement element C1 and the electric oil pump 21, and electronic controlling portions (an engine controlling portion 4, a transmission controlling portion 5 and an electric oil pump controlling portion 23) for controlling operations of the hydraulic pressure controlling portion 10, the power source 3 and the electric oil pump 2, respectively, on the basis of a signal indicating a predetermined state of a vehicle. The check valve 22 is configured so as to allow a supply of the hydraulic pressure from the electric oil pump 21 to the starting shift stage engagement element C1 and so as to avoid a reverse supply of the hydraulic pressure (i.e. the supply of the hydraulic pressure from the starting shift stage engagement element C1 to the electric oil pump 21). The electric oil pump 21 supplies the hydraulic pressure to the starting shift stage engagement element C1 via the hydraulic conduit, which differs from a hydraulic conduit (a second hydraulic conduit 9b) connected to the hydraulic pressure controlling portion 10. The check valve 22 is provided at the first hydraulic conduit 9a, which differs from the second hydraulic conduit 9b connected to the hydraulic pressure controlling portion 10.

### First Embodiment

A hydraulic pressure controlling apparatus according to a first embodiment will be described below with reference to the attached drawings.

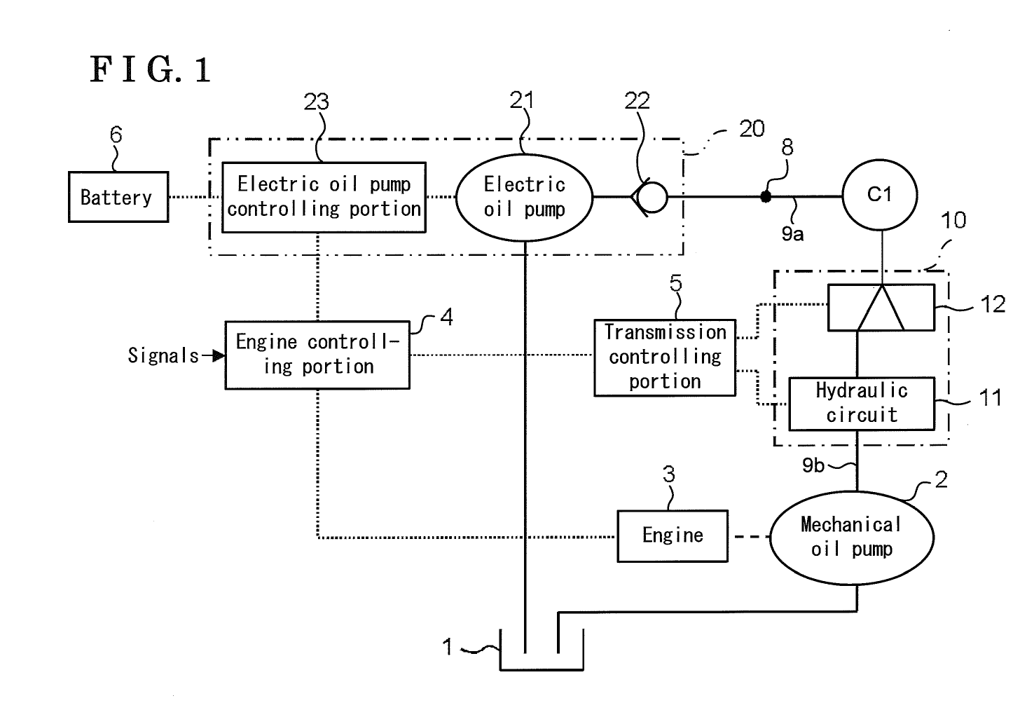

The hydraulic pressure controlling apparatus controls the hydraulic pressure supplied to the engagement elements of a hydraulic automatic transmission apparatus mounted on the vehicle. For example, the hydraulic pressure controlling apparatus may be adapted to an engine stop-and-start controlling apparatus, which automatically stops an engine 3 (an example of the power source) in a case where a stopping condition (a condition of stopping the engine 3) is satisfied when the vehicle stops (temporarily stops) at an intersection and the like while the vehicle is traveling and which automatically re-starts the engine 3 in a case where the staring condition (a condition of starting the engine 3) is satisfied afterwards. More specifically, as illustrated in FIG. 1, the hydraulic pressure controlling apparatus includes an oil pan 1, the mechanical oil pump 2, the engine 3, the engine controlling portion 4, the transmission controlling portion 5, a battery 6, a clutch C1 (i.e. a starting state engagement element, a first friction clutch C1), a C1 hydraulic pressure detection port 8, the hydraulic pressure controlling portion 10 and a hydraulic pressure maintaining portion 20.

The oil pan 1 is a container for accumulating (accommodating) an operation oil (an oil, an operation fluid) supplied to the hydraulic pressure controlling portion 10, the hydraulic pressure maintaining portion 20 and the like of the automatic transmission apparatus. More specifically, the operation oil drained from the hydraulic controlling portion 10 flows into the oil pan 1. The oil pan 1 includes therein a strainer for removing dust and the like contained in the operation oil. The operation oil within the oil pan 1 is supplied to the mechanical oil pump 2, the electric oil pump 21 and the like via the strainer.

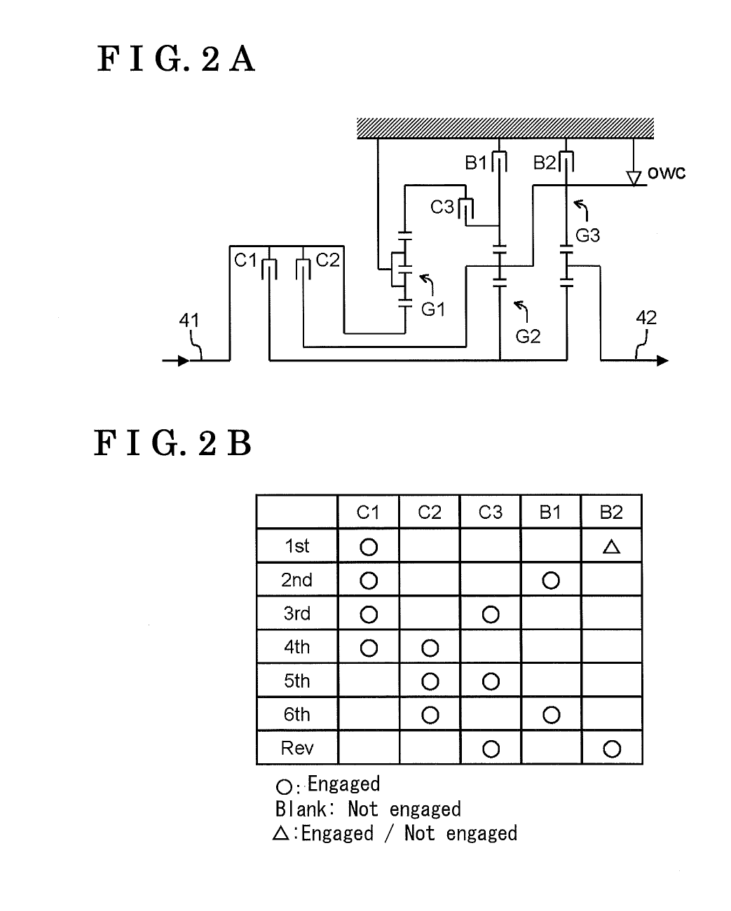

The mechanical oil pump 2 is an oil pump, which is actuated in response to a rotational power generated by the engine 3. The mechanical oil pump 2 itself does not include a power source. The mechanical oil pump 2 generates the hydraulic pressure for engaging mainly the engagement elements (C1, C2, C3, B1 and B2 in FIG. 2) used for establishing an appropriate shift stage within the automatic transmission apparatus. More specifically, the mechanical oil pump 2 sucks the operation oil within the oil pan 1 and discharges the operation oil to a hydraulic circuit 11 of the hydraulic pressure controlling portion 10. Additionally, in this embodiment, only the engine 3 serves as the power source for the mechanical oil pump 2. However, in a case where the hydraulic pressure controlling apparatus is adapted to a hybrid vehicle, an engine and a motor serve as power sources for the mechanical oil pump 2. On the other hand, in a case where the hydraulic pressure controlling apparatus is adapted to an electric vehicle, a motor serves as a power source for the mechanical oil pump 2.

The engine 3 is an internal combustion engine, which outputs the rotational power in response to combustion of a fuel. The rotational power generated by the engine 3 is transmitted to an input shaft 41 (see FIG. 2) of the automatic transmission apparatus via a torque converter. The engine 3 drives the mechanical oil pump 2. Furthermore, the engine 3 includes various actuators for adjusting an amount of fuel injection (including fuel cut) from an injector, an ignition timing and the like, and various sensors for detecting a number of rotations of the engine 3 (i.e. an engine rotating number, an engine rotating speed), an engine water temperature and the like. The amount of the fuel injection, the ignition timing and the like of the engine 3 are controlled by the engine controlling portion 4. A signal outputted from each sensor of the engine 3 is inputted to the engine controlling portion 4.

The engine controlling portion 4 is a computer that controls mainly each actuator of the engine 3. The engine controlling portion 4 executes a control processing on the basis of a predetermined program (including a database, a map and the like). The engine controlling portion 4 outputs various control signals to the engine 3, the transmission controlling portion 5, the electric oil pump controlling portion 23 and the like. Furthermore, various signals from an acceleration opening degree sensor, a shift position sensor, a rotation sensor and the like are inputted into the engine controlling portion 4. The engine controlling portion 4 may be electrically connected to each sensor. Alternatively, the engine controlling portion 4 may be electrically connected to each sensor via the transmission controlling portion 5, the electric oil pump controlling portion 23 or the like. The engine controlling portion 4 exchanges information with the transmission controlling portion 5 and the electric oil pump controlling portion 23. Furthermore, the engine controlling portion 4 controls automatic stop and re-start of the engine 3. In this embodiment, because the hydraulic pressure controlling apparatus is adapted to an engine-driven vehicle, the engine controlling portion 4 is provided at the hydraulic pressure controlling apparatus. Alternatively, in the case where the hydraulic pressure controlling apparatus is adapted to the hybrid vehicle, a hybrid controlling portion or an engine controlling portion may be used. On the other hand, in the case where the hydraulic pressure controlling apparatus is adapted to the electric vehicle, a motor controlling portion may be used.

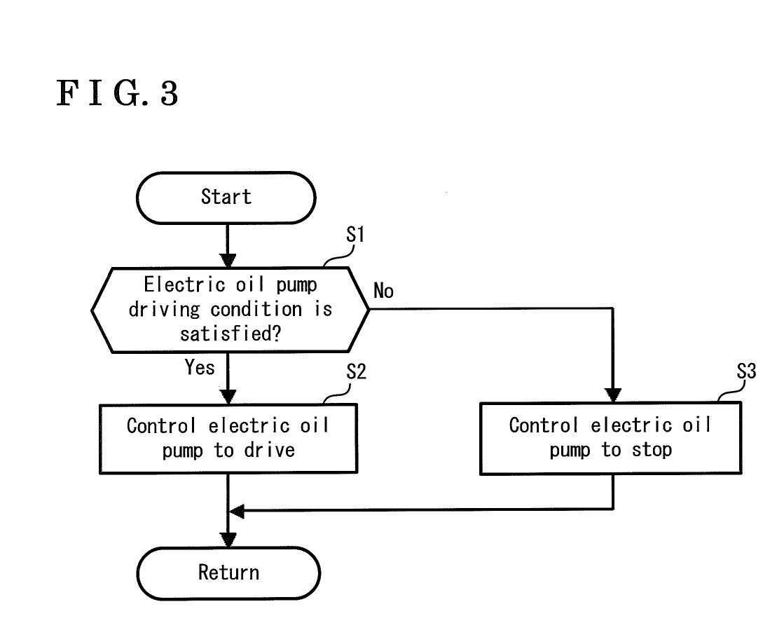

The engine controlling portion 4 determines whether or not a driving condition of the electric oil pump 21 (a condition of driving the electric oil pump 21) is satisfied (Step S1 in FIG. 3). In a case where the driving condition for driving the electric oil pump 21 is satisfied (Yes in Step S1), the engine controlling portion 4 executes a drive control to the electric oil pump 21 via the electric oil pump controlling portion 23, simultaneously, the engine controlling portion 4 controls a shift valve 21 via the transmission controlling portion 5 so that the shift valve 21 interrupts a flow of the operation oil between the first friction clutch C1 and the hydraulic circuit 11 in order to stop the engine 3 (Step S2). On the other hand, in a case where the driving condition for driving the electric oil pump 21 is not satisfied (No in Step S1), the engine controlling portion 4 executes a stop control to the electric oil pump 21 via the electric oil pump controlling portion 23, simultaneously, the engine controlling portion 4 controls the shift valve 12 via the transmission controlling portion 5 so that the shift valve 12 establishes the flow of the operation oil between the first friction clutch C1 and the hydraulic circuit 11 in order to re-start the engine 3 (Step S3). Additionally, a condition indicative of drivability of the electric oil pump 21 is used as the driving condition. For example, a condition such as an oil temperature being equal to or lower than a predetermined value, the engine rotating number being equal to or lower than a predetermined value, a battery level being equal to or greater than a predetermined value and the like, which are preliminarily set within the program of the engine controlling portion 4, are used as the driving condition.

The transmission controlling portion 5 is a computer that controls an operation of the hydraulic pressure controlling portion 10 of the automatic transmission apparatus. More specifically, the transmission controlling portion 5 controls operations of various solenoids provided at the hydraulic circuit 11 and the shift valve 12. Furthermore, the various signals outputted from various sensors, such as a hydraulic pressure sensor, a hydraulic pressure switch and the like, are inputted into the transmission controlling portion 5. The transmission controlling portion 5 exchanges information with the engine controlling portion 4.

As illustrated in FIG. 2A, the automatic transmission apparatus includes, for example, the input shaft 41, an output shaft 42, a first train double pinion planetary gear G1, a second train single pinion planetary gear G2, a third train single pinion planetary gear G3 and the engagement elements (C1, C2, C3, B1 and B2). The input shaft 41 is rotated together with an input portion of the first friction clutch C1, an input portion of the second friction clutch C2 and a sun gear of the first train double pinion planetary gear G1 as a unit. An output portion of the first friction clutch C1 is rotated together with a sun gear of the second train single pinion planetary gear G2 and a sun gear of the third train single pinion planetary gear G3 as a unit. An output portion of the second friction clutch C2 is rotated together with a carrier, which rotatably supports a pinion of the second train single pinion planetary gear G2, a ring gear of the third single pinion planetary gear G3, a rotating portion of the second friction brake B2, and a rotating portion of a one-way clutch OWC as a unit. An inner pinion and an outer pinion of the first train double pinion planetary gear G1 are rotatably supported by a carrier, which is fixed at a case. A ring gear of the second train single pinion planetary gear G2 is rotated together with an output portion of the third friction clutch C3 and a rotating portion of the first friction brake B1 as a unit. Fixing portions of the first friction brake B1, the second friction brake B2 and the one-way clutch are fixed at the case. The third train single pinion planetary gear G3 is rotatably supported by a carrier, which is rotated together with the output shaft 42 as a unit.

The automatic transmission apparatus is configured so as to switch the shift stages (see FIG. 2B) in response to a selection of engagement and disengagement of the engagement elements (C1, C2, C3, B1 and B2 in FIG. 2A) controlled by the transmission controlling portion 5 and the hydraulic pressure controlling portion 10. In a case where only the first friction clutch C1 (or only the first friction clutch C1 and the first friction brake B2) of the automatic transmission apparatus is engaged, a first shift stage is established. In a case where only the first friction clutch C1 and the first friction brake B1 of the automatic transmission apparatus are engaged, a second shift stage is established. In a case where only the first friction clutch C1 and the third friction clutch C3 of the automatic transmission apparatus are engaged, a third shift stage is established. In a case where only the first friction clutch C1 and the second friction clutch C2 of the automatic transmission apparatus are engaged, a fourth shift stage is established. In a case where only the second friction clutch C2 and the third friction clutch C3 of the automatic transmission apparatus are engaged, a fifth shift stage is established. In a case where only the second friction clutch C2 and the first friction brake B1 of the automatic transmission apparatus are engaged, a sixth shift stage is established. Furthermore, in a case where only the third friction clutch C3 and the second friction brake B2 of the automatic transmission apparatus are engaged, a reverse stage is established. In a case where the engine 3 is re-started after being automatically stopped, only the first friction clutch C1 serving as a starting clutch is engaged.

The battery 6 is a portion that accumulates therein an electric power. The battery 6 outputs the electric power to the electric oil pump controlling portion 23.

The first friction clutch C1 is an engagement element used for establishing the starting shift stage within the automatic transmission apparatus. More specifically, the first friction clutch C1 is pressed against a piston so as to be frictionally engaged in a case where a hydraulic pressure within a hydraulic pressure chamber of the first friction clutch C1 becomes high.

The C1 hydraulic pressure detection port 8 is a detection port provided on a hydraulic path in order to detect the hydraulic pressure (C1 hydraulic pressure) within the hydraulic pressure chamber of the piston, which is used for engaging the first friction clutch C1. The C1 hydraulic pressure detection port 8 is connected to the hydraulic conduit (i.e. the first hydraulic conduit 9a) led to the check valve 22 (i.e. a first check valve) of the hydraulic pressure maintaining portion 20. Generally, the C1 hydraulic pressure detection portion 8 is provided at the first hydraulic conduit 9a in order to connect thereto the hydraulic pressure sensor for detecting the C1 hydraulic pressure. However, in this embodiment, the hydraulic pressure sensor is not connected to the C1 hydraulic pressure detection portion 8, instead, the first hydraulic conduit 9a led to the check valve 22 is connected to the C1 hydraulic pressure detection port 8. Accordingly, a design change of the hydraulic pressure controlling portion 20 may become unnecessary.

The hydraulic pressure controlling portion 10 controls the hydraulic path and the hydraulic pressure of the operation oil supplied to the engagement elements of the automatic transmission apparatus. The hydraulic pressure controlling portion 10 includes the hydraulic circuit 11 and the shift valve 12.

The hydraulic circuit 11 controls the hydraulic path and adjusts the hydraulic pressure of the operation oil supplied thereto from the mechanical oil pump 2 in response to the control of the transmission controlling portion 5. Then, the hydraulic circuit 11 outputs the operation oil, whose pressure level is adjusted, to the shift valve 12. The hydraulic circuit 11 is configured with an appropriated combination of various valves, various solenoids and the like. Furthermore, the hydraulic circuit 11 controls the hydraulic path and adjusts the hydraulic pressure for other engagement elements (C2, C3, B1 and B2) in addition to the control and adjustment of the hydraulic path and the hydraulic pressure for the first friction clutch C1.

The shift valve 12 switches an establishment and an interruption of the hydraulic path (i.e. a flow of the operation oil) between the hydraulic circuit 11 and the first friction clutch C1. More specifically, the shift valve 12 executes the switching of the establishment and the interruption of the flow of the operation oil by actuating the solenoid thereof, which is controlled by the transmission controlling portion 5. For example, in a case where the engine 3 rotates, the shift valve 12 allows the operation oil to flow through the hydraulic conduit (the second hydraulic conduit 9b) extending between the hydraulic circuit 11 and the first friction clutch C1. On the other hand, in a case where the engine 3 does not rotate but the electric oil pump 21 is driven, the shift valve 12 interrupts the flow of the operation oil between the hydraulic circuit 11 and the first friction clutch C1. Additionally, the shift valve 12 may be configured so as to be included within the hydraulic circuit 11.

The hydraulic pressure maintaining portion 20 maintains the hydraulic pressure at a sufficient lever to engage the engagement element (i.e. the first friction clutch C1) used to form the starting shift stage in the case where the engine 3 is automatically stopped and the mechanical oil pump 2 is stopped, accordingly. The hydraulic pressure maintaining portion 20 is not configured within the hydraulic controlling portion 10. In other words, the hydraulic pressure maintaining portion 20 is configured separately of the hydraulic pressure controlling portion 10. The hydraulic pressure maintaining portion 20 includes the electric oil pump 21, the check valve 22 and the electric oil pump controlling portion 23.

The electric oil pump 21 is an electric oil pump driven by a motor. The electric oil pump 21 is provided at the hydraulic pressure controlling apparatus in order to support the mechanical oil pump 2. More specifically, the electric oil pump 21 generates the hydraulic pressure for engaging the engagement element (i.e. the first friction clutch C1) used to form the starting shift stage within the automatic transmission apparatus. The electric oil pump 21 sucks the operation oil within the oil pan 1 and discharges the operation oil to the check valve 22. Additionally, the electric oil pump 21 is controlled by the electric oil pump controlling portion 23.

The check valve 22 is a one-way valve that allows the operation oil to flow to the first friction clutch C1 from the electric oil pump 21 in a case where the hydraulic pressure at the electric oil pump 21 is greater than the hydraulic pressure at the first friction clutch C1. On the other hand, in a case where the hydraulic pressure at the electric oil pump 21 is lower than the hydraulic pressure at the first friction clutch C1, the check valve 22 prevents the reverse flow of the hydraulic oil, so that the operation oil from the electric oil pump 21 is not supplied to the first friction clutch C1

The electric oil pump controlling portion 23 is a controlling portion that controls the driving of the electric oil pump 21. More specifically, the electric oil pump controlling portion 23 controls the driving of the electric oil pump 21 in a manner where the electric oil pump controlling portion 23 controls the electric power supplied to the electric oil pump 21 from the battery 6 on the basis of the control signal outputted from the engine controlling portion 4. Various signals from various sensors, such as the rotating number sensor and the like of the electric oil pump 21 are inputted to the electric oil pump controlling portion 23. Furthermore, the electric oil pump controlling portion 23 exchanges information with the engine controlling portion 4.

An operation of the hydraulic pressure controlling apparatus according to the first embodiment will be described below.

In a case where only the engine 3 is driven, the mechanical oil pump 2 is actuated in response to the rotation of the engine 3, thereby sucking the operation oil from the oil pan 1. The operation oil discharged from the mechanical oil pump 2 is supplied to the first friction clutch C1 via the hydraulic circuit 11 and the shift valve 12, which are controlled so that the hydraulic pressure is supplied to the first friction clutch C1. The flow of the operation oil supplied to the first friction clutch C1 is stopped at the check valve 22, so that the operation oil does not flow into the electric oil pump 21. Additionally, in the case where the engine controlling portion 4 controls the engine 3 to be driven, the engine controlling portion 4 also controls the shift valve 12 via the transmission controlling portion 5 in order to establish the hydraulic path between the first friction clutch C1 and the hydraulic circuit 11.

In a case where only the electric oil pump 21 is actuated, the electric oil pump 21 sucks the operation oil from the oil pan 1 in response to the driving of the electric oil pump 21. The operation oil discharged from the electric oil pump 21 is supplied to the first friction clutch C1 via the check valve 22 and the C1 hydraulic pressure detection port 8. In this case, the flow of the operation oil between the first friction clutch C1 and the hydraulic circuit 11 is interrupted by the shift valve 12. Therefore, the operation oil supplied to the first friction clutch C1 from the electric oil pump 21 does not flow into the hydraulic circuit 11. Accordingly, leakage of the operation oil is limited to a small amount leaked from a clearance formed at the shift valve 12, in other words, the leakage of the operation oil is limited to a very small amount. Therefore, the electric oil pump 21 may be configured so as to have a minimum volume necessary for engaging the first friction clutch C1. Additionally, the electric oil pump 21 is controlled to be driven by the electric oil pump controlling portion 23, which receives a control command from the engine controlling portion 4, in order to control the hydraulic pressure and the flow of the operation oil so as to be sufficient to engage the first friction clutch C1. Furthermore, the engine controlling portion 4 monitors a condition of the vehicle such as the engine rotating number (i.e. the engine rotating speed), the oil temperature, the hydraulic pressure, a failure, a battery residual pressure and the like on the basis of the signals outputted from various sensors in order to output a control command corresponding to the monitored vehicle condition to the electric oil pump controlling portion 23. The engine controlling portion 4 controls the shift valve 12 via the transmission controlling portion 5 in order to interrupt the hydraulic path of the operation oil flowing between the first friction clutch C1 and the hydraulic circuit 11 in a case where the engine controlling portion 4 controls the electric oil pump 21 to be driven and the engine 3 to be stopped.

In a case where both of the electric oil pump 21 and the engine 3 are driven, the operation oil is supplied to the first friction clutch C1 from the mechanical oil pump 2 and the electric oil pump 21. In this case, the hydraulic path of the operation oil between the first friction clutch C1 and the hydraulic circuit 11 is established via the shift valve 12. Furthermore, a greater amount of the operation oil is supplied to the first friction clutch C1 from the mechanical oil pump 2 when comparing to an amount of the operation oil supplied to the first friction clutch C1 from the electric oil pump 21. However, because the flow of the operation oil supplied to the first friction clutch C1 from the mechanical oil pump 2 is interrupted by the check valve 22, the operation oil does not flow into the electric oil pump 21. Additionally, the engine controlling portion 4 controls the shift valve 12 via the transmission controlling portion 5 in order to establish the hydraulic path of the operation oil flowing between the first friction clutch C1 and the hydraulic circuit 11 in the case where the engine controlling portion 4 controls the engine 3 to be driven.

According to the hydraulic pressure controlling apparatus of the first embodiment, because the hydraulic pressure controlling portion 10 of the automatic transmission apparatus does not need to be newly designed in order to configure the hydraulic pressure maintaining portion 20, the hydraulic pressure controlling apparatus may be achieved at relatively low manufacturing costs. The hydraulic pressure maintaining portion 20 is configured so as to directly supply the hydraulic pressure to the starting clutch (i.e. the first friction clutch C1). Therefore, a length of a hydraulic conduit extending between the hydraulic pressure maintaining portion 20 and the starting clutch is set to be relatively short and the operation oil is not likely to leak from the hydraulic conduit between the hydraulic pressure maintaining portion 20 and the starting clutch. As a result, a size of the electric oil pump 21 may be reduced, which may further result in reducing a size of the hydraulic pressure controlling apparatus. Additionally, because the electric oil pump 21 is actuated with relatively low power and electricity consumption, a fuel consumption of the vehicle having the engine 3 may be reduced.

### Second Embodiment

A second embodiment of a hydraulic pressure controlling apparatus will be described below with reference to the attached drawing.

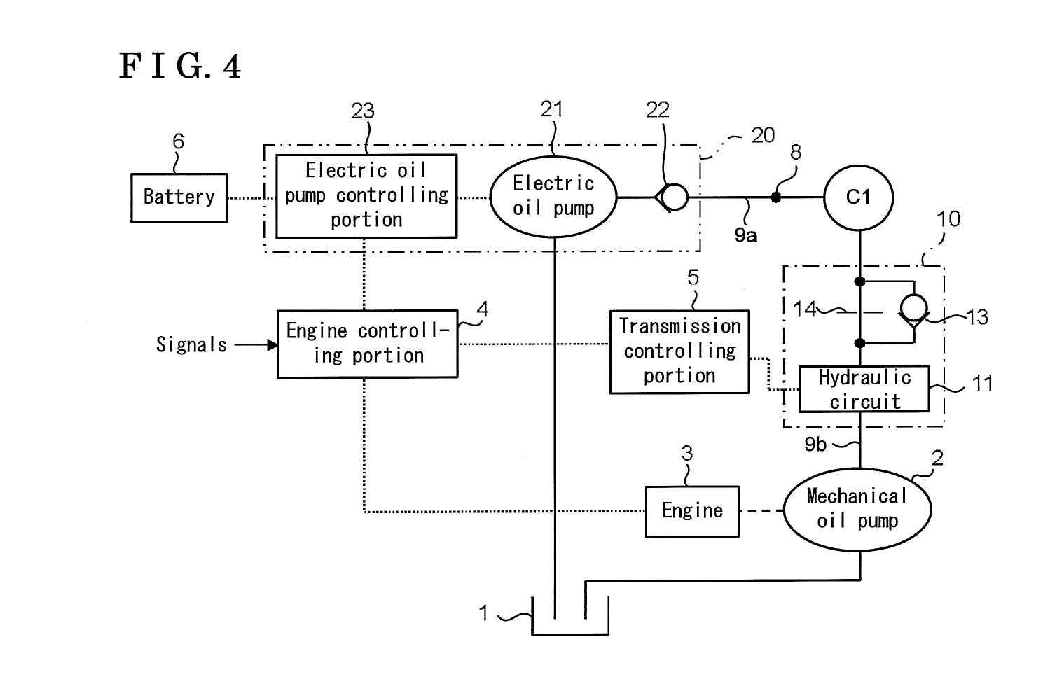

The hydraulic pressure controlling apparatus according to the second embodiment differs from the hydraulic pressure controlling apparatus according to the first embodiment in that the hydraulic pressure controlling apparatus according to the second embodiment includes a check valve 13 (i.e. a second check valve) and an orifice 14 instead of the shift valve 12 of the hydraulic pressure controlling apparatus according to the first embodiment. As illustrated in FIG. 4, the check valve 13 and the orifice 14 are arranged in parallel with each other at the second hydraulic conduit 9b connecting the hydraulic circuit 11 and the first friction clutch C1. The orifice 14 controls the flow of the operation oil flowing through the second hydraulic conduit 9b extending between the hydraulic circuit, 11 and the first friction clutch C1. The check valve 13 is a one-way valve for supplying the operation oil from the hydraulic circuit 11 to the first friction clutch C1 in a case where the hydraulic pressure at the hydraulic circuit 11 is greater than the hydraulic pressure at the first friction clutch C1. Other configurations of the hydraulic pressure controlling apparatus according to the second embodiment are substantially similar to the hydraulic pressure controlling apparatus according to the first embodiment. Therefore, only the differences between the hydraulic pressure controlling apparatus of the first embodiment and the hydraulic pressure controlling apparatus of the second embodiment will be described below.

In the first embodiment, the flow of the operation oil outputted from the electric oil pump 21 is interrupted by the shift valve 12, so that the operation oil does not flow into the hydraulic circuit 11. On the other hand, according to the second embodiment, the flow of the operation oil outputted from the electric oil pump 21 is interrupted by the check valve 13, so that a small amount of the operation oil is allowed to flow into the hydraulic circuit 11 via the orifice 14 in order to maintain the hydraulic pressure necessary for engaging the first friction clutch C1. Furthermore, in the first embodiment, the operation oil discharged from the mechanical oil pump 2 is supplied to the first friction clutch C1 via the shift valve 12, which is controlled by the engine controlling portion 4 and the transmission controlling portion 5. On the other hand, according to the second embodiment, the operation oil discharged from the mechanical oil pump 2 is supplied to the first friction clutch C1 via the check valve 13 and the orifice 14, which are not controlled by the engine controlling portion 4 and the transmission controlling portion 5.

According to the second embodiment, the hydraulic pressure controlling apparatus achieves advantages and merits similar to the advantages and merits of the hydraulic pressure controlling apparatus of the first embodiment. Furthermore, according to the second embodiment, the configuration of the hydraulic pressure controlling portion 10 is simplified, which may further result in reducing the size of the hydraulic pressure controlling apparatus.

According to the first embodiment, the hydraulic pressure controlling portion 10 includes the hydraulic circuit 11, to which the hydraulic pressure generated by the mechanical oil pump 2 is supplied, and the shift valve 12 provided at the second hydraulic conduit 9b extending between the hydraulic circuit 11 and the first friction clutch C1 and is switchable between the state of allowing the supply of the hydraulic pressure to the first friction clutch C1 from the mechanical oil pump 2 and the state of interrupting the supply of the hydraulic pressure, which is supplied to the first friction clutch C1 from the electric oil pump 21, to the hydraulic circuit 11. The engine controlling portion 4 controls the flow of the operation oil flowing through the hydraulic circuit 11 and the operation of the shift valve 12 via the transmission controlling portion 5.

According to the second embodiment, the hydraulic pressure controlling portion 10 includes the hydraulic circuit 11, to which the hydraulic pressure generated by the mechanical oil pump 2 is supplied, the check valve 13, which is provided at the second hydraulic conduit 9b extending between the hydraulic circuit 11 and the first friction clutch C1, allows the supply of the hydraulic pressure from the mechanical oil pump 2 to the first friction clutch C1 and interrupts the hydraulic pressure, which is supplied to the first friction clutch C1 from the electric oil pump 21, to be reversely supplied to the hydraulic circuit 11, and the orifice 14, which is arranged in parallel with the check valve 13 at the second hydraulic conduit 9b extending between the hydraulic circuit 11 and the first friction clutch C1 and controls the flow of the operation oil flowing through the second hydraulic conduit 9b extending between the hydraulic circuit 11 and the first friction clutch C1. The engine controlling portion 4 controls the flow of the operation oil flowing through the hydraulic circuit 11 via the transmission controlling portion 5.

According to the embodiments, the engine controlling portion 4 controls the electric oil pump 21 so as not to be driven via the electric oil pump controlling portion 23 in the case where the engine controlling portion 4 determines that the driving condition of the electric oil pump 21 is not satisfied on the basis of the signal indicating the predetermined state of the vehicle.

According to the embodiments, the power source includes at least one of the engine 3 and the motor.

According to the embodiments, the first hydraulic conduit 9a which differs from the second hydraulic conduit 9b connecting the hydraulic pressure controlling portion 10 and the first friction clutch C1, is connected to the C1 hydraulic pressure detection port 8 for detecting the hydraulic pressure supplied to the first friction clutch C1.

According to the first embodiment, the engine controlling portion 4 controls the operation of the shift valve 12 via the transmission controlling portion 5 so that the shift valve 12 allows the operation oil to flow between the hydraulic circuit 11 and the first friction clutch C1 through the second hydraulic conduit 9b in the case where the engine 3 is driven and interrupts the flow of the operation oil between the hydraulic circuit 11 and the first friction clutch C1 in the case where the engine 3 is not driven and the electric oil pump 21 is driven.

According to the embodiments, the power source includes the engine 3.

According to the second embodiment, the orifice 14 and the check valve 13 are arranged in parallel with each other relative to the second hydraulic conduit 9b extending between the hydraulic circuit 11 and the first friction clutch C1.

Accordingly, because an additional hydraulic pressure controlling portion does not need to be newly provided at the automatic transmission apparatus in order to maintain the hydraulic pressure necessary for engaging the first friction clutch C1 (CN: the starting shift stage engagement element) when the engine 3 (CR the power source) is stopped, the manufacturing costs of the hydraulic pressure controlling apparatus of the embodiments (CN: this disclosure) may be reduced. Furthermore, because the hydraulic pressure is directly supplied to the first friction clutch C1 (CN: the starting shift stage engagement element) from the electric oil pump 21, the first hydraulic conduit 9a extending between the electric oil pump 21 and the first friction clutch C1 (i.e. the (?) starting clutch) may be shortened and the operation oil is not likely to leak from the first hydraulic conduit 9a. As a result, the size of the electric oil pump 21 may be reduced, which may further result in reducing the size of the hydraulic pressure controlling apparatus. Additionally, because the electric oil pump 21 is actuated with relatively low power and electricity consumption, the fuel consumption of the vehicle having the engine 3 (CN: the power source) may be reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the disclosure. Accordingly, it is expressly intended that all such variations, changes and equivalents which fall within the spirit and scope of the present invention as defined in the claims, be embraced thereby.

1. A hydraulic pressure controlling apparatus comprising:
a hydraulic pressure controlling portion controlling a hydraulic pressure supplied to plural engagement elements of an automatic transmission apparatus;
a mechanical oil pump generating the hydraulic pressure and supplying the hydraulic pressure to the hydraulic pressure controlling portion in response to a driving of a power source;
an electric oil pump generating the hydraulic pressure and supplying the hydraulic pressure to a starting shift stage engagement element, which is one of the plural engagement elements used for establishing a starting shift stage;
a first check valve provided at a first hydraulic conduit extending between the starting shift stage engagement element and the electric oil pump, allowing a supply of the hydraulic pressure outputted from the electric oil pump to the starting shift stage engagement element and interrupting the hydraulic pressure to be reversely supplied from the starting shift stage engagement element to the electric oil pump; and
an electronic controlling portion controlling operations of the hydraulic pressure controlling portion, the power source and the electronic oil pump on the basis of a signal indicating a predetermined state of a vehicle, wherein
the electric oil pump supplies the hydraulic pressure to the starting shift stage engagement element via the first hydraulic conduit, which differs from a second hydraulic conduit connecting the hydraulic pressure controlling portion and the starting shift stage engagement element, and
the first check valve is provided at the first hydraulic conduit.

2. The hydraulic pressure controlling apparatus according to claim 1, wherein the hydraulic pressure controlling portion includes a hydraulic circuit, to which the hydraulic pressure generated by the mechanical oil pump is supplied, and a shift valve provided at the second hydraulic conduit extending between the hydraulic circuit and the starting shift stage engagement element and is switchable between a state of interrupting a supply of the hydraulic pressure, which is supplied to the starting shift stage engagement element from the electric oil pump, to the hydraulic circuit and a state of allowing the supply of the hydraulic pressure to the starting shift stage engagement element from the mechanical oil pump, and the electronic controlling portion controls the flow of an operation fluid flowing through the hydraulic circuit and an operation of the shift valve.

3. The hydraulic pressure controlling apparatus according to claim 1, wherein the hydraulic pressure controlling portion includes a hydraulic circuit, to which the hydraulic pressure generated by the mechanical oil pump is supplied, a second check valve, which is provided at the second hydraulic conduit extending between the hydraulic circuit and the starting shift stage engagement element, allows the supply of the hydraulic pressure from the mechanical oil pump to the starting shift stage engagement element and interrupts the hydraulic pressure, which is supplied to the starting shift stage engagement element from the electric oil pump, to be reversely supplied to the hydraulic circuit, and an orifice, which is arranged in parallel with the second check valve at the second hydraulic conduit extending between the hydraulic circuit and the starting shift stage engagement element and controls the flow of an operation fluid flowing through the second hydraulic conduit extending between the hydraulic circuit and the starting shift stage engagement element, and the electronic controlling portion controls the flow of the operation fluid flowing through the hydraulic circuit.

4. The hydraulic pressure controlling apparatus according to claim 1, wherein the electronic controlling portion controls the electric oil pump so as not to be driven in a case where the electronic controlling portion determines that a driving condition of the electric oil pump is not satisfied on the basis of the signal indicating the predetermined state of the vehicle.

5. The hydraulic pressure controlling apparatus according to claim 1, wherein the power source includes at least one of an engine and a motor.

6. The hydraulic pressure controlling apparatus according to claim 1, wherein the first hydraulic conduit, which differs from the second hydraulic conduit connecting the hydraulic pressure controlling portion and the starting shift stage engagement element, is connected to a detection port for detecting the hydraulic pressure supplied to the starting shift stage engagement element.

7. The hydraulic pressure controlling apparatus according to claim 2, wherein the electronic controlling portion controls the electric oil pump so as not to be driven in a case where the electronic controlling portion determines that a driving condition of the electric oil pump is not satisfied on the basis of the signal indicating the predetermined state of the vehicle.

8. The hydraulic pressure controlling apparatus according to claim 3, wherein the electronic controlling portion controls the electric oil pump so as not to be driven in a case where the electronic controlling portion determines that a driving condition of the electric oil pump is not satisfied on the basis of the signal indicating the predetermined state of the vehicle.

9. The hydraulic pressure controlling apparatus according to claim 2, wherein the first hydraulic conduit, which differs from the second hydraulic conduit connecting the hydraulic pressure controlling portion and the starting shift stage engagement element, is connected to a detection port for detecting the hydraulic pressure supplied to the starting shift stage engagement element.

10. The hydraulic pressure controlling apparatus according to claim 3, wherein the first hydraulic conduit, which differs from the second hydraulic conduit connecting the hydraulic pressure controlling portion and the starting shift stage engagement element, is connected to a detection port for detecting the hydraulic pressure supplied to the starting shift stage engagement element.

11. The hydraulic pressure controlling apparatus according to claim 2, wherein the power source includes an engine.

12. The hydraulic pressure controlling apparatus according to claim 2, wherein the electronic controlling portion controls the operation of the shift valve so that the shift valve allows the operation fluid to flow between the hydraulic circuit and the starting shift stage engagement element through the second hydraulic conduit in a case where the power source is driven and interrupts the flow of the operation fluid between the hydraulic circuit and the starting shift stage engagement element in a case where the power source is not driven and the electric oil pump is driven.

13. The hydraulic pressure controlling apparatus according to claim 12, wherein the power source includes an engine.

14. The hydraulic pressure controlling apparatus according to claim 3, wherein the orifice and the second check valve are arranged in parallel with each other relative to the second hydraulic conduit extending between the hydraulic circuit and the starting shift stage engagement element.
